(19) United States
(12) Patent Application Publication
(10) Pub. No.: US 2013/0235581 A1
(43) Pub. Date: Sep. 12, 2013

(54) LENS ARRAY ASSEMBLY FOR SOLID STATE LIGHT SOURCES AND METHOD

(71) Applicant: George IATAN, Saint-Lambert (CA)

(72) Inventor: George IATAN, Saint-Lambert (CA)

(73) Assignee: DBM REFLEX ENTERPRISES INC., Laval, QC (CA)

(21) Appl. No.: 13/871,397

(22) Filed: Apr. 26, 2013

Related U.S. Application Data
(63) Continuation of application No. PCT/CA2011/050675, filed on Oct. 27, 2011.
(60) Provisional application No. 61/407,416, filed on Oct. 27, 2010.

(51) Int. Cl. F21V 5/00; B29D 11/00

(52) U.S. Cl. CPC F21V 5/007; B29D 11/0074
USPC 362/238; 362/335; 264/1.7

(57) ABSTRACT

The lens array assembly includes a lens array support made of a first molded plastic material exhibiting a volumetric shrinkage upon cooling, the lens array support having a plurality of spaced-apart apertures; and an array of lenses made of second molded plastic material exhibiting a volumetric shrinkage upon cooling, each lens corresponding to one of the apertures of the lens array support and having an actual position in the lens array support that is within a maximum tolerance of 0.20 mm compared to each lens design position.

### CROSS-REFERENCE TO RELATED APPLICATIONS

The present case is a continuation of PCT Patent Application No. PCT/CA2011/050675 filed on 27 Oct. 2011, which claims priority to U.S. Patent Application Ser. No. 61/407,416 filed on 27 Oct. 2010, the content of both of which is incorporated herein by reference.

### TECHNICAL FIELD

The technical field relates generally to large area illumination apparatuses including an array of solid state light sources optically coupled to a lens array assembly. More particularly, it relates to lens array assemblies made of two components that are joined by overmolding.

### BACKGROUND

Large area illumination devices using arrays of solid state light sources such as light emitting diodes (LEDs) coupled to an array of lenses are known, such as for street and roadway illumination, parking lots, factories and sport arenas, to name just a few. Reference is made in this regard to the following examples: PCT patent application No. WO 2009/145892 to Ruud Lighting, PCT patent application No. WO 2009/149558 to Lumec, PCT patent application No. WO 2009/149559 to Philips, US published patent application No. 2007/0201225 to Holder and PCT patent application No. WO 2010/057311 to DBM Reflex.

FIG. 1 is a semi-schematic cross-sectional view illustrating an example of a lens array 10 and an example of a generic solid state light source array 12 as found in the prior art. The solid state light sources 14, for instance LEDs, are provided on a substrate 16, such as a printed circuit board (PCB). It should be noted that the solid state light sources 14 are not limited to LEDs and other kinds of solid state light sources can be used as well.

In this example, the lens array 10 includes a plurality of interconnected lenses 18 that are molded together so as to form a monolithic unit. These lenses 18 are used as light collectors. The molding can be made, for instance, by injection molding. This, however, creates a number of challenges, especially if the lens array 10 is relatively large in length and/or in width (for instance having a dimension A in the order of 50 millimeters or more). Once the lens array 10 is formed, it will cool. The material used for making these lenses exhibits a volumetric shrinkage and this will somewhat offset the lenses 18 with reference to the corresponding solid state light sources 14. When the lens array 10 is relatively large, the volumetric shrinkage can become significant.

FIG. 2 is an enlarged semi-schematic cross-sectional view of one of the lenses 18 and the corresponding solid state light source 14 in FIG. 1. As can be seen, the center axis of the lens 18 is offset with the center axis of the solid state light source 14. If the alignment is not perfect as shown, the efficiency of the light collection decreases. This efficiency falls rapidly if the tolerance is above 0.20 mm. For most applications, this is not desirable. For instance, in the case of a street lamp post, the lens array can have a width of about 600 mm. Shrinkage will create many misalignment issues in this case.

FIG. 3 is a semi-schematic cross-sectional view illustrating an example of a lens array assembly 20 and an example of a generic solid state light source array 22 cooperating with the lens array assembly 20 as found in the prior art. In this example, a lens array support 24 is used and the lenses 26 are mounted one by one in the lens array support 24. The lens array support 24 can be made, for instance, of aluminum or another metallic material. Other materials are also possible as well. The positioning of the lenses 26 can be greatly improved using such arrangement. However, assembling and positioning the lenses 26 on the lens array support 24 add cost and complexity.

There is always a need to improve the design and the manufacturing of the lens arrays to simplify the design, the manufacturing, the assembling and/or the operation of illumination devices using an array of lenses coupled to solid state light sources to achieve the maximum light output. The maximum or the optimum light output depends among others on the accuracy of the alignment between the solid state light sources and the lens array.

There is a need to develop a lens array assembly that are more accurate, simpler and easier to manufacture and assemble in conjunction with solid state light sources and the associated electronic boards.

There is also a need to improve the injection molding process of large area lens arrays such as lens arrays that exceed 50 mm in length in one dimension to better control the post mold shrinkage. Shrinkage depends on many geometrical, materials and injection molding factors and has an adversarial effect when molding array of optical components located on a large supports that exceed for example 50 mm in length.

Furthermore, there is a need to mass manufacture large arrays of lenses by injection molding and reduce the shrinkage of the molded array in order to better control the alignment between an array of LEDs and the array of lenses that is affected by post mold shrinkage.

There is also a need to further develop lens arrays where the lenses generate the light beams of maximum efficiency based only on total internal reflection as having all the reflective surfaces uncoated. There is a need to improve the alignment between these TIR lenses and the solid state light sources for large area illumination devices.

Accordingly, there is still room for many improvements in this area of technology.

### SUMMARY

In one aspect, there is provided a lens array assembly including: a lens array support made of a first molded plastic material exhibiting a volumetric shrinkage upon cooling, the lens array support having a plurality of spaced-apart apertures; and an array of lenses made of second molded plastic material exhibiting a volumetric shrinkage upon cooling, each lens corresponding to one of the apertures of the lens array support and having an actual position in the lens array support that is within a maximum tolerance of 0.20 mm compared to each lens design position.

In another aspect, there is provided a method of injection molding a composite and integral lens array, the method including: injection molding a lens array support using a first molten material in a first mold having a first mold cavity and a plurality of spaced apart mold core inserts corresponding to the number of lenses in the lens array, the mold core inserts for forming a plurality of mechanical apertures in the lens support corresponding to the number of lenses, each mechanical aperture having an aperture axis and one of a diameter D or a lengths L and a width W, each mechanical aperture being spaced apart from an adjacent mechanical aperture by a first pitch P1 measured between the axis of the two adjacent mechanical apertures, and where the two most marginal and distant mechanical apertures within a raw of mechanical apertures are spaced apart by a first maximal distance MD1 measured between the axis of these two mechanical apertures; injection molding a lens array support using a first molten material in a first mold having a first mold cavity and a plurality of spaced apart mold core inserts corresponding to the number of lenses in the lens array, the mold core inserts for forming a plurality of mechanical apertures in the lens support corresponding to the number of lenses, each mechanical aperture having an aperture axis and one of a diameter D or a lengths L and a width W, each mechanical aperture being spaced apart from an adjacent mechanical aperture by a first pitch P1 measured between the axis of the two adjacent mechanical apertures, and where the two most marginal and distant mechanical apertures within a raw of mechanical apertures are spaced apart by a first maximal distance MD1 measured between the axis of these two mechanical apertures; ejecting the molded lens array support from the first mold and cooling the lens array support outside the first mold for a first cooling time that insures a first shrinkage of the lens array support that causes a first dimensional change of the first pitch P1 to a second pitch P2 that further translates into a lateral shift of the axis of each mechanical aperture and a first dimensional change in the maximal distance MD1 to a second maximal distance MD2; positioning the cooled molded lens array support that is located and retained on a mold cold half in alignment with a mold hot half to form a second mold, the second mold having a plurality of second mold cavities, where the mold hot half further including an injection manifold and a plurality of hot runner nozzles, where each of the mechanical apertures of the molded lens array support has a surface, the surface further defining at least a portion of each second mold cavities; injecting an array of lenses using a second molten material through the hot runner nozzles and into the second mold cavities defined at least partially by the surface of the mechanical aperture, where the second molten material injected in the second mold cavities makes direct contact and bonds with the surface of the mechanical apertures of the lens support to form the composite and integral lens array; cooling the molded composite and integral lens array that causes a second shrinkage of the molded composite and integral lens array to achieve a final pitch P and a final maximal distance MD, where the change from the first pitch P to the final pitch P is less than the first shrinkage of the molded lens array support and where each of the mechanical aperture has been initially dimensioned to include an additional gap to compensate for the lateral shift of each mechanical aperture axis caused by the first shrinkage and the second shrinkage and thus position each lens molded in the lens array support within an axial shift tolerance relative to an array of illumination sources that is smaller than an axial shift tolerance obtainable by injection molding the lenses into the lens array support without the additional gap; and ejecting the molded composite and integral lens array from the second mold cavity and further cooling the composite and integral lens array.

Further details on these aspects as well as other aspects of the proposed concept will be apparent from the following detailed description and the appended figures.

### BRIEF DESCRIPTION OF THE FIGURES

FIG. 1 is a semi-schematic cross-sectional view illustrating an example of a lens array and an example of a generic solid state light source array as found in the prior art;

FIG. 2 is an enlarged semi-schematic cross-sectional view of one of the lens and the corresponding solid state light source in FIG. 1;

FIG. 3 is a semi-schematic cross-sectional view illustrating an example of a lens array assembly and an example of a generic solid state light source array as found in the prior art;

FIG. 4 is a semi-schematic cross-sectional view illustrating an example of a molded lens array support made in accordance with the concept presented herein;

FIG. 5 is a schematic top view of an example of a lens array support;

FIG. 6 is a view illustrating an example of an arrangement for molding the lenses in the lens array support;

FIG. 7 is a view similar to FIG. 6, showing another example of an arrangement for molding the lenses in the lens array support;

FIG. 8 is a semi-schematic cross-sectional view illustrating an example of the resulting lens array assembly; and

FIG. 9 is a view similar to FIG. 2, showing the reduced tolerance obtained using the concept presented herein.

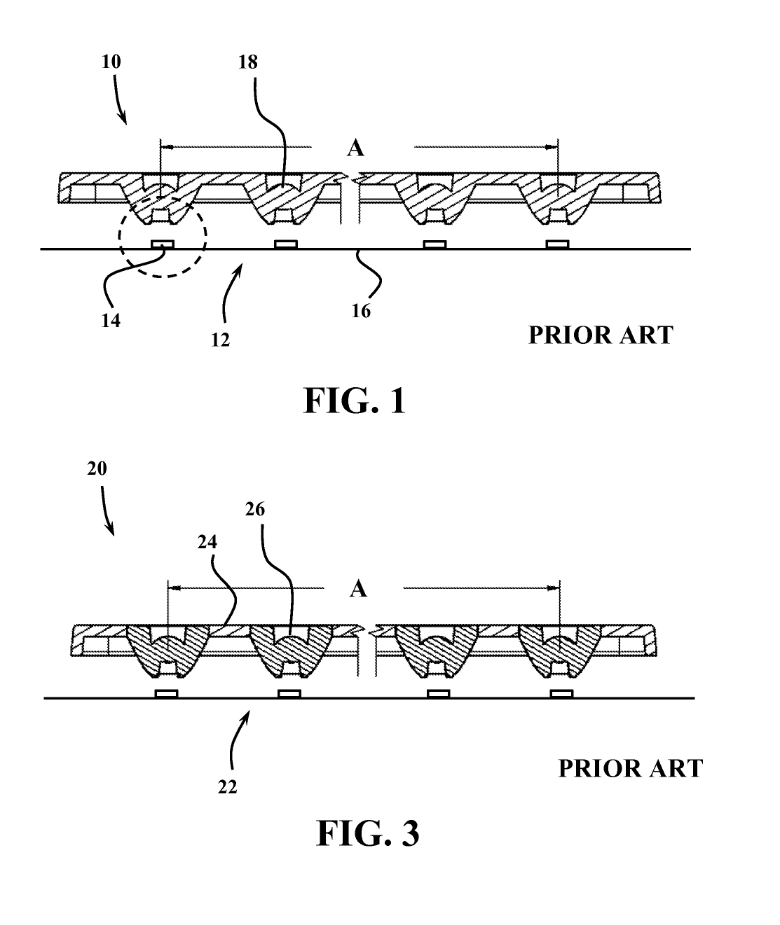

### DETAILED DESCRIPTION

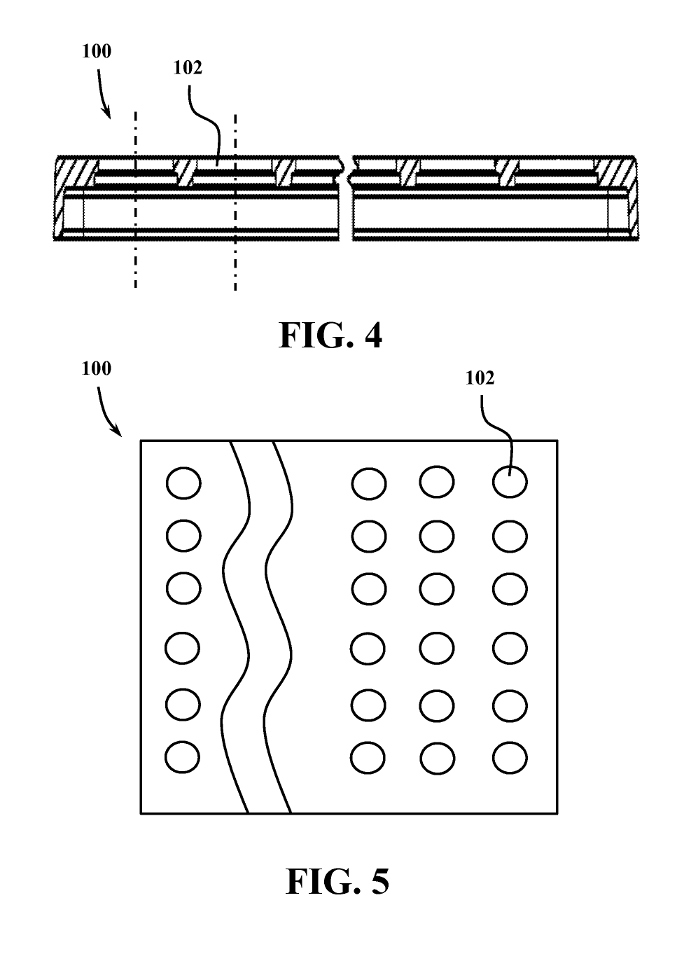

FIG. 4 is a semi-schematic cross-sectional view illustrating an example of a molded lens array support 100 made in accordance with the concept presented herein. The lens array support 100 is made of a first molded material exhibiting a volumetric shrinkage upon cooling. The lens array support 100 has a plurality of spaced-apart apertures 102. The size and shape of these apertures 102 depend on the design requirements. The apertures 102 form an array.

FIG. 5 is a schematic top view of an example of a lens array support 100. This example shows an array of identical apertures 102 forming regular rows and columns. Other configurations are possible as well. For instance, the apertures 102 can be staggered or otherwise disposed.

The lens array support 100 can be made of various colors and plastic materials such as polypropylene, polyethylene, ABS, ABS/PC, Nylon, polycarbonate, POM or any other plastic material used for housing or casing.

In the concept present herein, the lens array support 100 is allowed to cool at least partially before lenses are overmolded thereon. For instance, the cooling can be done while the lens array support 100 is still inside the mold and other lens array supports are being molded in other juxtaposed molds. The mold can be cooled by an internal cooling circuit to cool the lens array support 100 therein. The lenses can be molded immediately thereafter. In another implementation, the lens array support 100 can be removed from the mold and allowed to be cooled down to room temperature before the lenses are molded.

Each aperture 102 in the lens array support 100 can be made larger than an optical portion of the corresponding lens. This way, the actual size of the apertures 102 after shrinkage will have no direct impact on the positioning of the lenses.

The lenses are molded on the lens array support in a second step. The lenses are made of second molded material exhibiting a volumetric shrinkage upon cooling. Each lens corresponds to one of the apertures 102 of the lens array support 100.

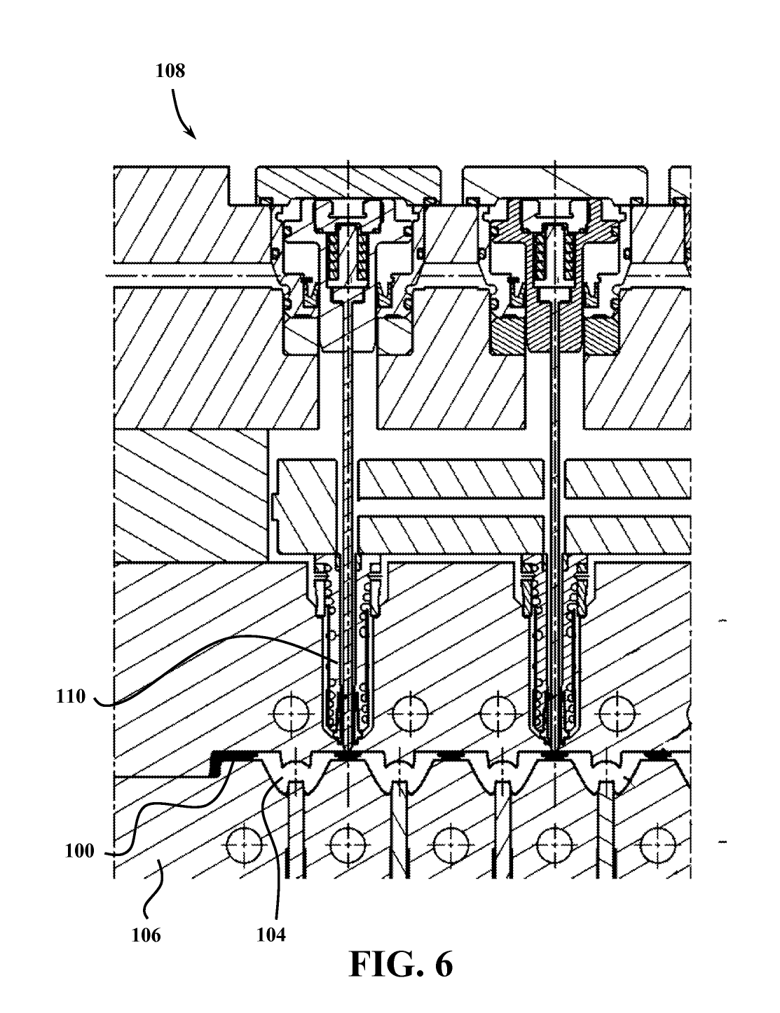

FIG. 6 is a view illustrating an example of an arrangement for molding the lenses 104 in the lens array support 100. It shows the mold 106 for the lenses 104 provided inside the molding apparatus 108. In this example, the second material is injected using less nozzles 110 than the number of lenses 104. The molten material flows inside channels (not shown) in the mold 106 for filing adjacent cavities in the mold 106. The lenses 104, however, will not be in direct contact with one another after the molding. They will all be supported by the lens array support 100.

If each aperture 102 is made larger than the optical portion of the lenses 104, each lens 104 will include a peripheral rim connecting the optical portion to an interior of the corresponding aperture 102. This actual size of each aperture 102 will thus have no impact on the precision of the positioning the lenses 104.

The lenses 104 can be molded using various transparent plastic materials such as acrylic, polycarbonate, APEC, Styrene, COC or any other plastic material used for transparent or optical application. In some implementations, the lens array support 100 and the lenses 104 can be made of the same material.

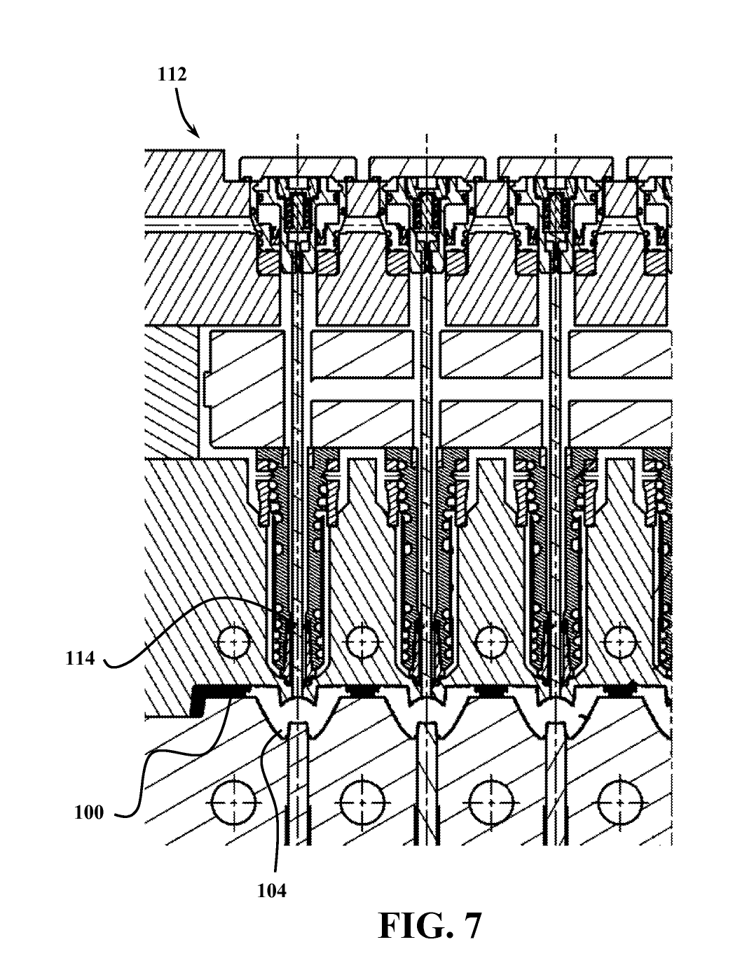

FIG. 7 is a view similar to FIG. 6, showing another example of an arrangement for molding the lenses 104 in the lens array support 100. In this example, the apparatus 112 includes one nozzle 114 for each cavity forming a lens 104. This, however, increases the costs of the apparatus 112 compared to the apparatus 108 shown in FIG. 6.

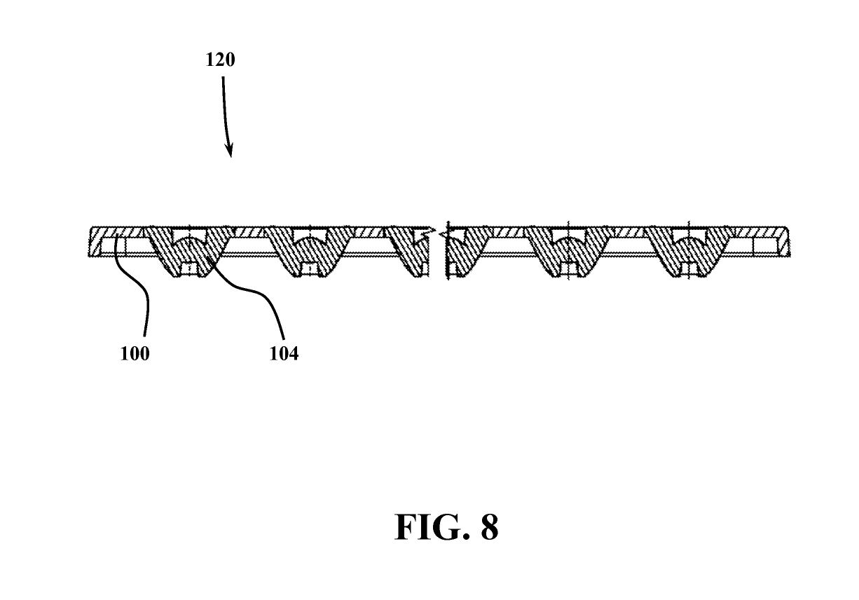

FIG. 8 is a semi-schematic cross-sectional view illustrating an example of the resulting lens array assembly 120 with reference to a solid state light source 122. As can be appreciated, each lens 104 therein will have an actual position in the lens array support 100 that is within a maximum tolerance of 0.20 mm compared to each lens design position. The design position is the ideal position of each lens 104, thus the position where the light collection with their corresponding solid state light source will be optimum.

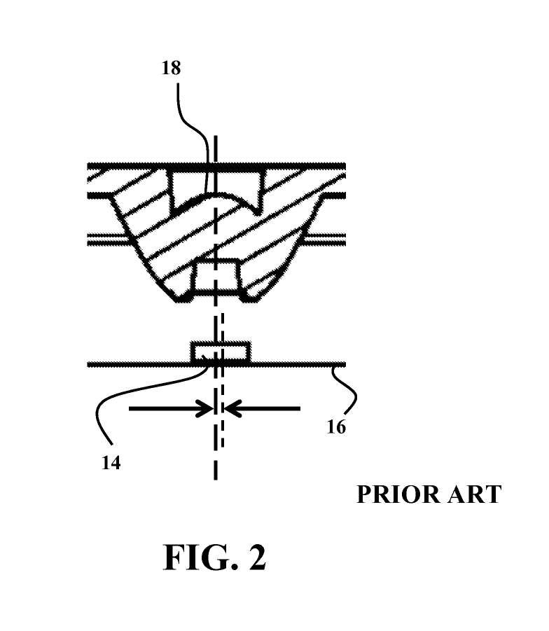

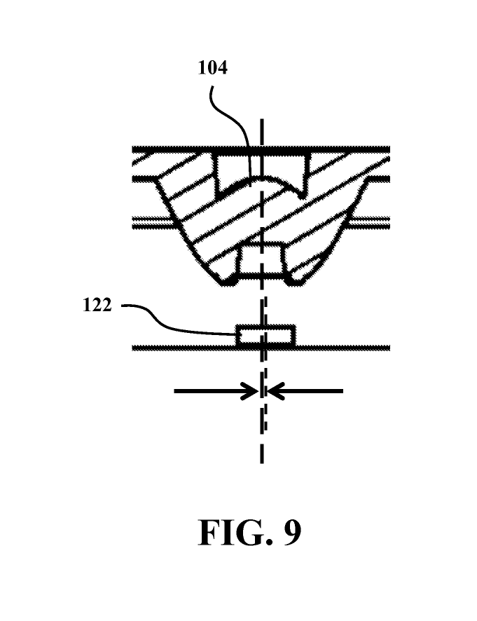

FIG. 9 is a view similar to FIG. 2, showing the reduced tolerance obtained using the concept presented herein. In many implementations, the maximum tolerance can be below 0.15 mm.

The present concept also provides a method of injection molding a composite and integral lens array, the method including:
injection molding a lens array support using a first molten material in a first mold having a first mold cavity and a plurality of spaced apart mold core inserts corresponding to the number of lenses in the lens array, the mold core inserts for forming a plurality of mechanical apertures in the lens support corresponding to the number of lenses, each mechanical aperture having an aperture axis and one of a diameter D or a lengths L and a width W, each mechanical aperture being spaced apart from an adjacent mechanical aperture by a first pitch P1 measured between the axis of the two adjacent mechanical apertures, and where the two most marginal and distant mechanical apertures within a raw of mechanical apertures are spaced apart by a first maximal distance MD1 measured between the axis of these two mechanical apertures;
injection molding a lens array support using a first molten material in a first mold having a first mold cavity and a plurality of spaced apart mold core inserts corresponding to the number of lenses in the lens array, the mold core inserts for forming a plurality of mechanical apertures in the lens support corresponding to the number of lenses, each mechanical aperture having an aperture axis and one of a diameter D or a lengths L and a width W, each mechanical aperture being spaced apart from an adjacent mechanical aperture by a first pitch P1 measured between the axis of the two adjacent mechanical apertures, and where the two most marginal and distant mechanical apertures within a raw of mechanical apertures are spaced apart by a first maximal distance MD1 measured between the axis of these two mechanical apertures;
ejecting the molded lens array support from the first mold and cooling the lens array support outside the first mold for a first cooling time that insures a first shrinkage of the lens array support that causes a first dimensional change of the first pitch P1 to a second pitch P2 that further translates into a lateral shift of the axis of each mechanical aperture and a first dimensional change in the maximal distance MD 1 to a second maximal distance MD2;
positioning the cooled molded lens array support that is located and retained on a mold cold half in alignment with a mold hot half to form a second mold, the second mold having a plurality of second mold cavities, where the mold hot half further including an injection manifold and a plurality of hot runner nozzles, where each of the mechanical apertures of the molded lens array support has a surface, the surface further defining at least a portion of each second mold cavities;
injecting an array of lenses using a second molten material through the hot runner nozzles and into the second mold cavities defined at least partially by the surface of the mechanical aperture, where the second molten material injected in the second mold cavities makes direct contact and bonds with the surface of the mechanical apertures of the lens support to form the composite and integral lens array;
cooling the molded composite and integral lens array that causes a second shrinkage of the molded composite and integral lens array to achieve a final pitch P and a final maximal distance MD, where the change from the first pitch P to the final pitch P is less than the first shrinkage of the molded lens array support and where each of the mechanical aperture has been initially dimensioned to include an additional gap to compensate for the lateral shift of each mechanical aperture axis caused by the first shrinkage and the second shrinkage and thus position each lens molded in the lens array support within an axial shift tolerance relative to an array of illumination sources that is smaller than an axial shift tolerance obtainable by injection molding the lenses into the lens array support without the additional gap; and
ejecting the molded composite and integral lens array from the second mold cavity and further cooling the composite and integral lens array.

The second material can be injection molded using valve gated hot runner nozzles.

The second material can be injection molded using a single valve gated hot runner nozzle for each lens, where the melt is injected directly in the second mold cavity.

The second material can be injection molded using a single valve gated hot runner nozzle for at least two lenses via cold runners communicating with each cavity of the second mold.

The second material can be injection molded using thermal gated hot runner nozzles.

The second material can be injection molded using a single thermal gated hot runner nozzle for each lens, where the melt is injected directly in the second mold cavity.

The second material can be injection molded using a single thermal gated hot runner nozzle for at least two lenses via cold runners communicating with each cavity of the second mold.

The first and the second materials are identical or the material of the lens array support can be different than the material of the lenses.

The material of the lens array support can have a higher strength and a higher rigidity compared to the material of the lenses.

The lens array support can be molded using a cold runner sprue bushing.

The present detailed description and the appended figures are meant to be exemplary only. A skilled person will recognize that variants can be made in light of a review of the present disclosure without departing from the proposed concept.

What is claimed is:

1. A lens array assembly including:
a lens array support made of a first molded plastic material exhibiting a volumetric shrinkage upon cooling, the lens array support having a plurality of spaced-apart apertures; and
an array of lenses made of second molded plastic material exhibiting a volumetric shrinkage upon cooling, each lens corresponding to one of the apertures of the lens array support and having an actual position in the lens array support that is within a maximum tolerance of 0.20 mm compared to each lens design position.

2. The lens array assembly as defined in claim 1, wherein each lens design position corresponds to a position of a respective solid state light source mounted on a substrate.

3. The lens array assembly as defined in claim 2, wherein the solid state light sources include light emitting diodes.

4. The lens array assembly as defined in claim 1, wherein the maximum tolerance is 0.15 mm.

5. The lens array assembly as defined in claim 1, wherein each aperture in the lens array support is made larger than an optical portion of the corresponding lens, each lens including a peripheral rim connecting the optical portion to an interior of the corresponding aperture.

6. The lens array assembly as defined in claim 1, wherein the lenses are only directly connected to one another by the lens array support.

7. A method of injection molding a composite and integral lens array, the method including:
injection molding a lens array support using a first molten material in a first mold having a first mold cavity and a plurality of spaced apart mold core inserts corresponding to the number of lenses in the lens array, the mold core inserts for forming a plurality of mechanical apertures in the lens support corresponding to the number of lenses, each mechanical aperture having an aperture axis and one of a diameter D or a lengths L and a width W, each mechanical aperture being spaced apart from an adjacent mechanical aperture by a first pitch P1 measured between the axis of the two adjacent mechanical apertures, and where the two most marginal and distant mechanical apertures within a raw of mechanical apertures are spaced apart by a first maximal distance MD1 measured between the axis of these two mechanical apertures;
injection molding a lens array support using a first molten material in a first mold having a first mold cavity and a plurality of spaced apart mold core inserts corresponding to the number of lenses in the lens array, the mold core inserts for forming a plurality of mechanical apertures in the lens support corresponding to the number of lenses, each mechanical aperture having an aperture axis and one of a diameter D or a lengths L and a width W, each mechanical aperture being spaced apart from an adjacent mechanical aperture by a first pitch P1 measured between the axis of the two adjacent mechanical apertures, and where the two most marginal and distant mechanical apertures within a raw of mechanical apertures are spaced apart by a first maximal distance MD1 measured between the axis of these two mechanical apertures;
ejecting the molded lens array support from the first mold and cooling the lens array support outside the first mold for a first cooling time that insures a first shrinkage of the lens array support that causes a first dimensional change of the first pitch P1 to a second pitch P2 that further translates into a lateral shift of the axis of each mechanical aperture and a first dimensional change in the maximal distance MD 1 to a second maximal distance MD2;
positioning the cooled molded lens array support that is located and retained on a mold cold half in alignment with a mold hot half to form a second mold, the second mold having a plurality of second mold cavities, where the mold hot half further including an injection manifold and a plurality of hot runner nozzles, where each of the mechanical apertures of the molded lens array support has a surface, the surface further defining at least a portion of each second mold cavities;
injecting an array of lenses using a second molten material through the hot runner nozzles and into the second mold cavities defined at least partially by the surface of the mechanical aperture, where the second molten material injected in the second mold cavities makes direct contact and bonds with the surface of the mechanical apertures of the lens support to form the composite and integral lens array;
cooling the molded composite and integral lens array that causes a second shrinkage of the molded composite and integral lens array to achieve a final pitch P and a final maximal distance MD, where the change from the first pitch P to the final pitch P is less than the first shrinkage of the molded lens array support and where each of the mechanical aperture has been initially dimensioned to include an additional gap to compensate for the lateral shift of each mechanical aperture axis caused by the first shrinkage and the second shrinkage and thus position each lens molded in the lens array support within an axial shift tolerance relative to an array of illumination sources that is smaller than an axial shift tolerance obtainable by injection molding the lenses into the lens array support without the additional gap; and
ejecting the molded composite and integral lens array from the second mold cavity and further cooling the composite and integral lens array.

8. The method as defined in claim 7, wherein the second material is injection molded using valve gated hot runner nozzles.

9. The method as defined in claim 8, wherein the second material is injection molded using a single valve gated hot runner nozzle for each lens, where the melt is injected directly in the second mold cavity.

10. The method as defined in claim 8, wherein the second material is injection molded using a single valve gated hot runner nozzle for at least two lenses via cold runners communicating with each cavity of the second mold.

11. The method as defined in claim 7, wherein the second material is injection molded using thermal gated hot runner nozzles.

12. The method as defined in claim 8, wherein the second material is injection molded using a single thermal gated hot runner nozzle for each lens, where the melt is injected directly in the second mold cavity.

13. The method as defined in claim 8, wherein the second material is injection molded using a single thermal gated hot runner nozzle for at least two lenses via cold runners communicating with each cavity of the second mold.

14. The method as defined in claim 7, wherein the first and the second materials are identical.

15. The method as defined in claim 7, wherein the material of the lens array support is different than the material of the lenses.

16. The method as defined in claim 7, wherein the material of the lens array support has a higher strength and a higher rigidity compared to the material of the lenses.

17. The method as defined in claim 7, wherein the lens array support is molded using a cold runner sprue bushing.
